(19) United States
(12) Patent Application Publication
(10) Pub. No.: US 2024/0011456 A1
(43) Pub. Date: Jan. 11, 2024

(54) Tidal stream generation apparatus

(71) Applicant: Feng-Yan Shen, Pingtung (TW)

(72) Inventor: Feng-Yan Shen, Pingtung (TW)

(21) Appl. No.: 18/233,901

(22) Filed: Aug. 15, 2023

(51) Int. Cl. F03B 13/08; F03B 3/02

(52) U.S. Cl. CPC F03B 13/08; F03B 3/02; F05B 2220/32; F05B 2220/7064

(57) ABSTRACT

A generating apparatus for generating electrical power from a water flow to electrical energy includes a support structure; an electrical power generation arrangement; and a drain tank. The support structure includes a pipe extending into seawater, a tidal stream generation device in the pipe, and a water tank in fluid communication with the pipe. The tidal stream generation device includes a turbine for directing seawater from the pipe therein, a shaft co-rotated with the turbine, a reduction gearbox connected to the shaft, an output shaft extending out of the reduction gearbox, an alternator driven by the output shaft to convert mechanical energy to electrical energy, and an electrical grid electrically connected to the alternator. The electrical power generation arrangement includes at least one electrical energy generation device in communication with the water tank. Each electrical energy generation device includes interconnected bends and tidal stream generators in the bends.

### BACKGROUND OF THE INVENTION

### 1. Field of the Invention

The invention relates to tidal stream generators and more particularly to a tidal stream generation apparatus having improved characteristics.

### 2. Description of Related Art

Conventionally, tidal stream generators are mounted below or above the surface of the seawater. However, it may obstruct navigation.

There is a conventional apparatus for generating electrical power from a horizontal water flow. The apparatus comprises a fixed hub on a support structure and a power wheel arranged for rotation about a vertical axis about the hub. The power wheel includes rotor vanes adapted to cause rotation of the power wheel when the power wheel is subject to a substantially horizontal water flow. At least one generator can be provided on the hub to produce electrical power output from rotation of the power wheel relative to the hub. A shroud is rotationally mounted on the hub and arranged to cover at least some of the rotor vanes, so that the water flow is concentrated on the rotor vanes on only one side of the power wheel. A directional controller holds the shroud in a predetermined rotational position relative to the hub dependent on the direction of the water flow.

### SUMMARY OF THE INVENTION

It is therefore one object of the invention to provide a generating apparatus for generating electrical power from a water flow to electrical energy, comprising a support structure; an electrical power generation arrangement; and a drain tank; wherein the support structure includes a pipe extending out of the support structure to allow seawater to flow through, at least one tidal stream generation device in the pipe, a water discharging member in the pipe, and a water tank being in fluid communication with the pipe and proximate the water discharging member; wherein each of the least one tidal stream generation device includes a turbine for directing seawater from the pipe therein, a shaft coaxially provided with and co-rotated with the turbine, a reduction gearbox operatively connected to the shaft, an output shaft extending out of the reduction gearbox, an alternator driven by the output shaft to convert mechanical energy to electrical energy in the form of alternating current (AC), and an electrical grid electrically connected to the alternator; wherein the water discharging member is in fluid communication with the water tank so that the water tank is configured to store seawater flowing through the at least one tidal stream generation device and the water discharging member; wherein the water tank includes an outlet proximate a bottom for flowing seawater to the electrical power generation arrangement; wherein the electrical power generation arrangement includes at least one electrical energy generation device on a bottom; wherein a level of the water tank is higher than a height of each of the at least one electrical energy generation device so that gravitation of seawater in the water tank is configured to flow to each of the at least one electrical energy generation device; wherein each of the at least one electrical energy generation device includes a plurality of bends connected together and a plurality of tidal stream generators disposed in the bends; wherein seawater flowing through the bends is configured to activate the tidal stream generators to convert mechanical energy to electrical energy in the form of AC; wherein the electrical grid electrically connected to each of the tidal stream generators; and wherein the drain tank is connected to an end of each of the at least one electrical energy generation device so that seawater is configured to flow from the electrical energy generation device to the drain tank; and wherein the drain tank includes an outlet for discharging seawater to the sea.

Preferably, further comprises a water level indicator disposed on an upper portion of an outer surface of the water tank.

Preferably, further comprises at least one hole disposed on a lower portion of an outer surface of the water tank for discharging sea water out of the water tank.

Preferably, a size of an inlet of the pipe is configured to adjust.

Preferably, seawater is configured to flow to the sea through the outlet of the drain tank if the drain tank is disposed above the surface of seawater.

Preferably, seawater is configured to flow into the tidal stream generation device for electrical power generation through the pipe if the support structure is disposed under the surface of seawater.

The invention has the following advantages and benefits in comparison with the conventional art:

Both the tidal stream generation devices and the electrical energy generation device are used to generate electrical energy, thereby increasing performance. No pollution. Tides are fully utilized.

The reduction gearbox in cooperation with the tidal stream generation devices and the tidal stream generator can increase electrical power output.

The above and other objects, features and advantages of the invention will become apparent from the following detailed description taken with the accompanying drawings.

### BRIEF DESCRIPTION OF THE DRAWINGS

FIG. 1 is a side elevation in part section of a tidal stream generating apparatus according to the invention;

FIG. 2 is a schematic perspective view of the support structure in FIG. 1;

FIG. 3 is a side elevation in part section of the support structure in FIG. 2;

FIG. 4 is a perspective view of the tidal stream generation device;

FIG. 5 is a flowchart illustrating operations of the tidal stream generation device;

FIG. 6 is a schematic perspective view of the electrical power generation arrangement in FIG. 1;

FIG. 7 is a perspective view of the electrical energy generation device;

FIG. 8 is an elevation in part section of a portion of FIG. 7 and the schematic electrical grid; and

FIG. 9 is an enlarged view of the drain tank in FIG. 1.

### DETAILED DESCRIPTION OF THE INVENTION

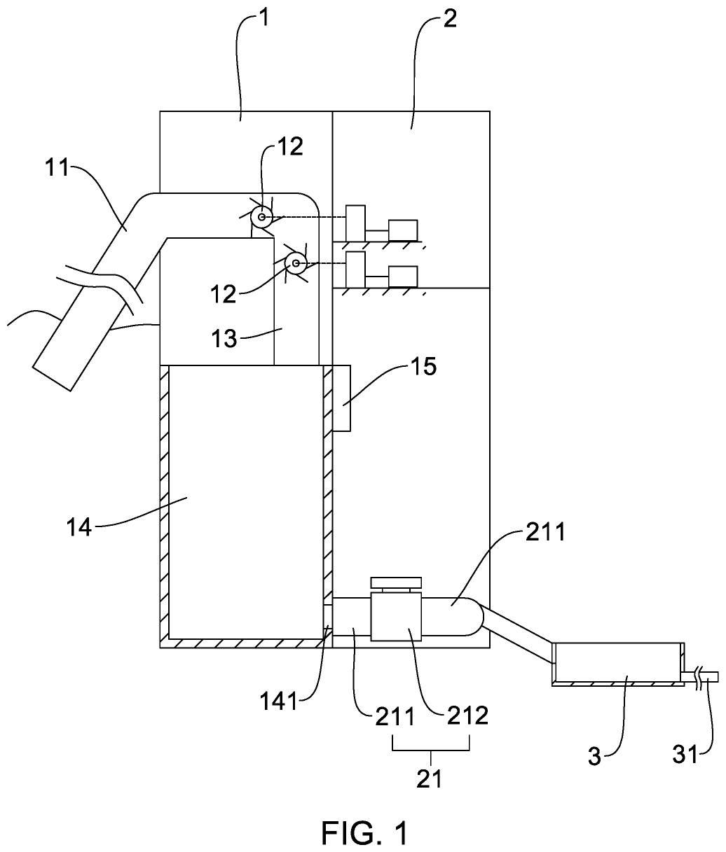

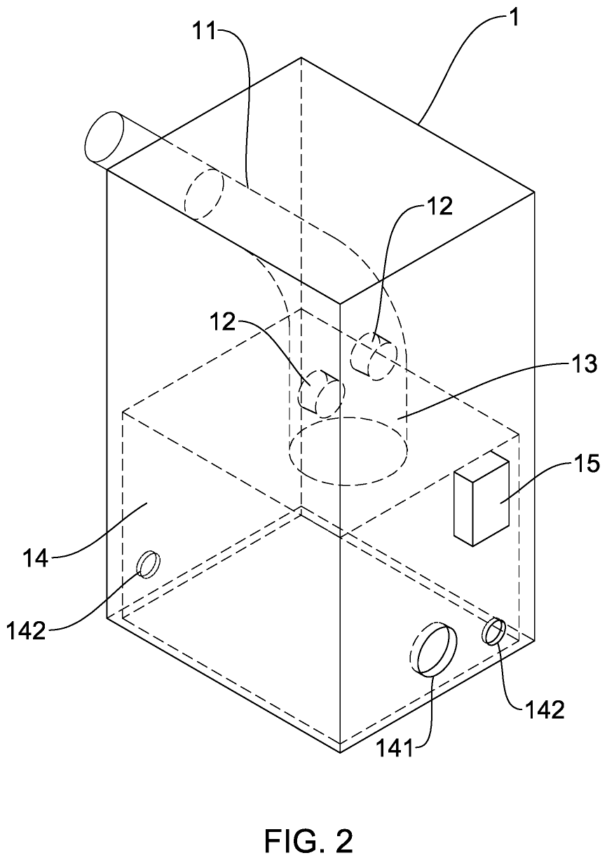

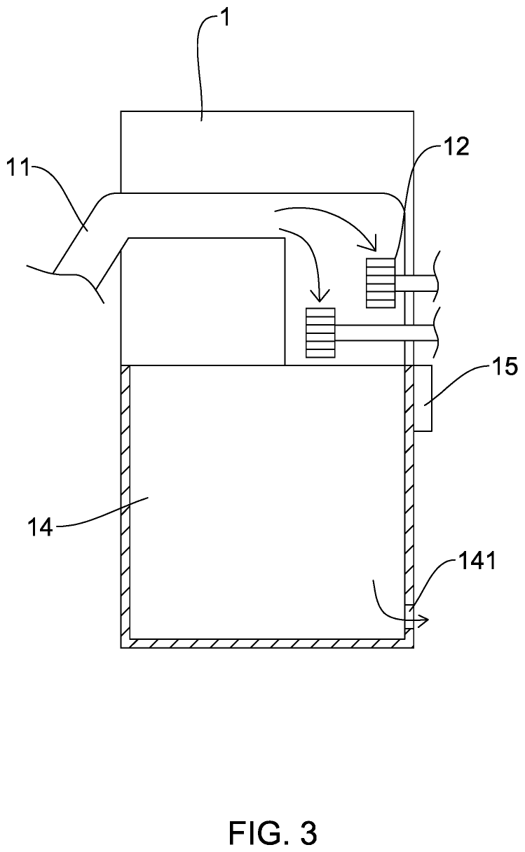

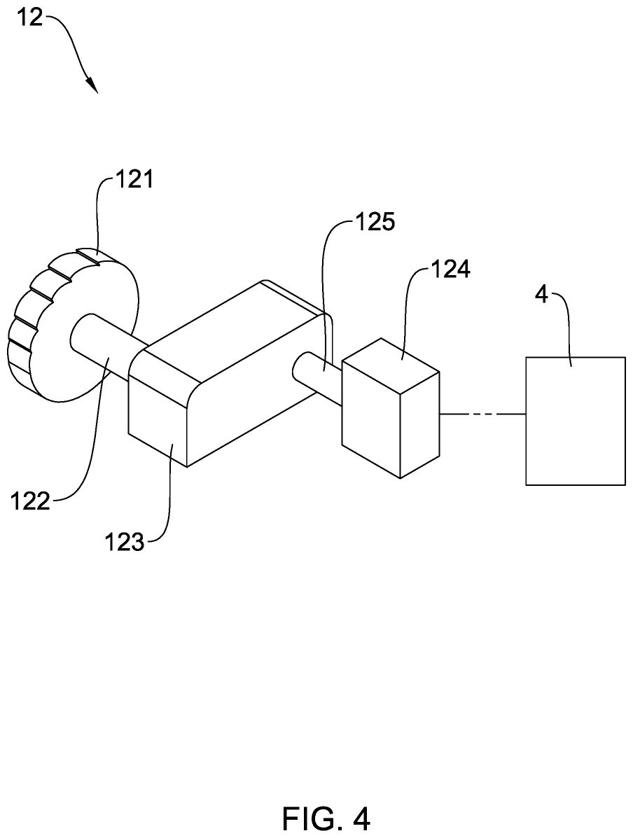

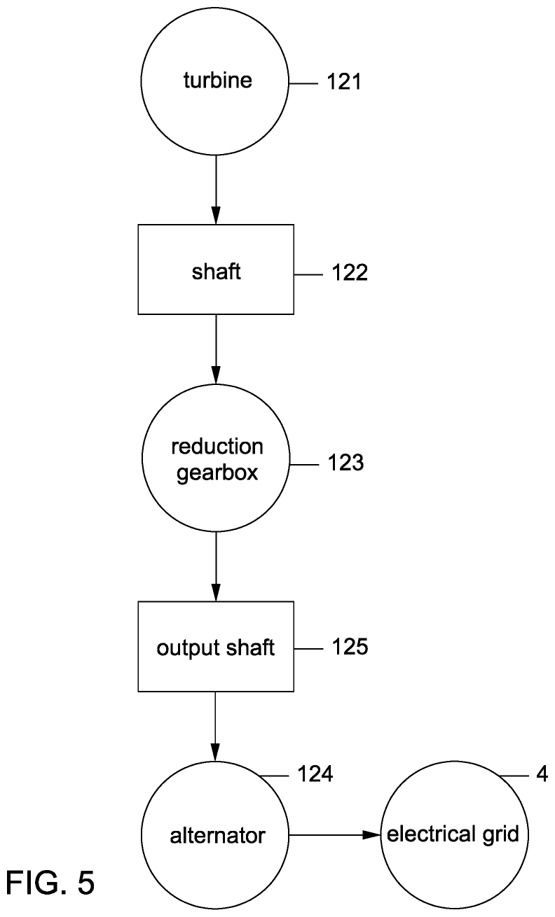

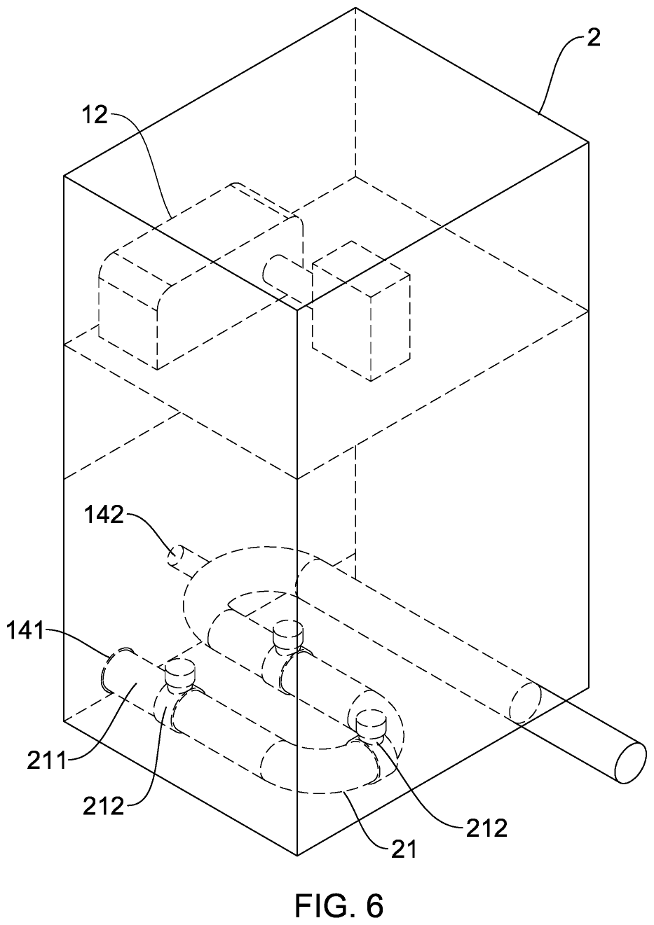

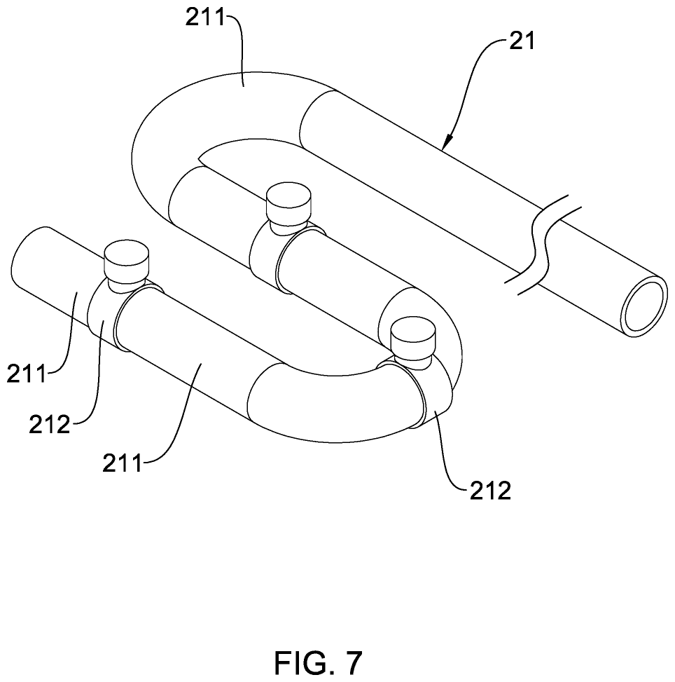

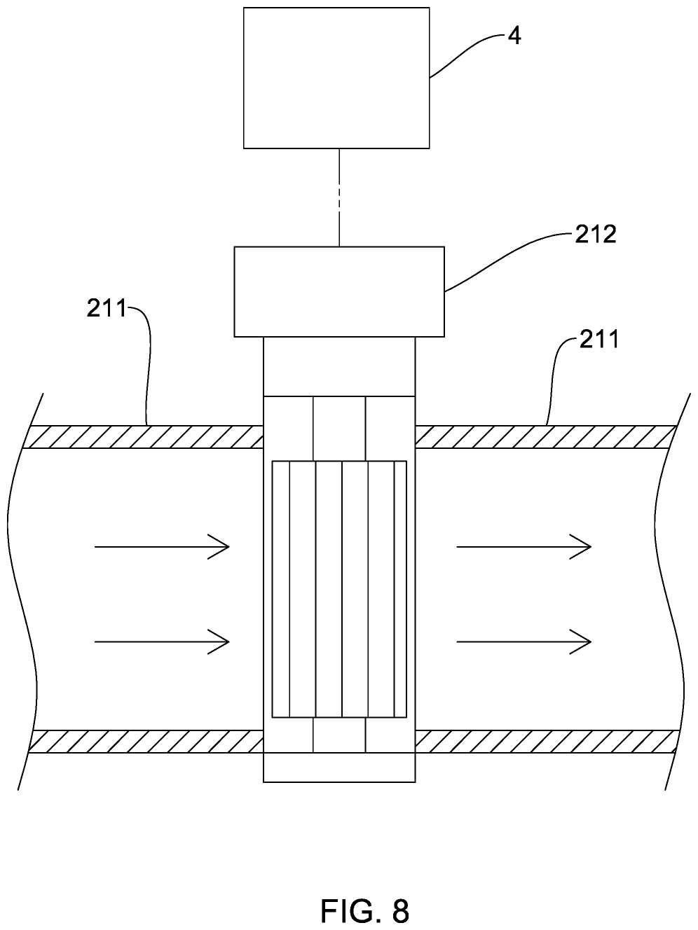

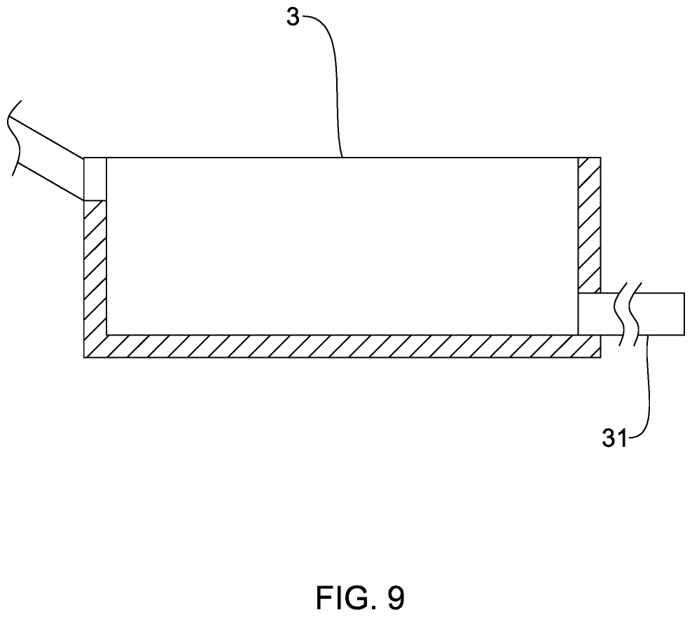

Referring to FIGS. 1 to 9, a tidal stream generating apparatus in accordance with a preferred embodiment of the invention comprises a support structure 1, an electrical power generation arrangement 2, and a drain tank 3 as discussed in detail below.

The support structure 1 includes a pipe 11 extending to the sea, two tidal stream generation devices 12 proximate an inner end of the pipe 11, a water discharging member 13 at the inner end of the pipe 11, and a water tank 14 in fluid communication with the inner end of the pipe 11. A number of the pipe 11, a number of the tidal stream generation device 12, and a number of the water discharging member 13 are provided in other embodiments.

Seawater flows through the pipe 11 to the tidal stream generation device 12 which converts the kinetic energy of the seawater into electrical energy. Specifically, the support structure 1 is disposed below or above the surface of seawater. A pump (not shown) is used to draw seawater into the tidal stream generation device 12 for electrically power generation through the pipe 11 if the support structure 1 is disposed above the surface of seawater. Seawater automatically flows into the tidal stream generation device 12 for electrical power generation through the pipe 11 if the support structure 1 is disposed under the surface of seawater. Size of the inlet of the pipe 11 can be adjusted. Alternatively, there are more than one pipe 11 provided and each pipe 11 communicates with one of the tidal stream generation devices 12.

The tidal stream generation device 12 includes a turbine 121, a shaft 122 coaxially provided with and co-rotated with the turbine 121, a reduction gearbox 123 operatively connected to the shaft 122, an output shaft 125 extending out of the reduction gearbox 123, and an alternator 124 driven by the output shaft 125 to convert mechanical energy to electrical energy in the form of alternating current (AC) by means of a rotating magnetic field with a stationary armature. AC power is transmitted to an electrical grid 4 which in turn delivers same to consumers. The turbine 121 includes a plurality of blades (not shown) which co-rotate with the shaft 122 when flowing seawater is directed on the blades to create a force on the blades. The reduction gearbox 123 includes a number of gears (not shown) to change speed of rotation of the output shaft 125.

The water discharging member 13 is in fluid communication with the water tank 14 so that the water tank 14 may store seawater flowing through the tidal stream generation devices 12. An outlet 141 is provided proximate bottom of the water tank 14 for flowing seawater to the electrical power generation arrangement 2.

There is further provided with a water level indicator 15 on an upper portion of an outer surface of the water tank 14 so that an employee may determine whether water level in the water tank 14 reaches the turbine 121. Two holes 142 are provided on a lower portion of the outer surface of the water tank 14 for discharging sea water out of the water tank 14.

An electrical energy generation device 21 is provided on a bottom of the electrical power generation arrangement 2 and has one end connected to the hole 141. The level of the water tank 14 is higher than the height of the electrical energy generation device 21 so that gravitation of seawater in the water tank 14 may flow to the electrical energy generation device 21. An office (not shown) is provided above the electrical energy generation device 21 and has an elevation greater than that of the tidal stream generation device 12.

The electrical energy generation device 21 includes a plurality of bends 211 connected together and a plurality of tidal stream generators 212 provided in the bends 211. Water flowing from the water tank 14 through the bends 211 may activate the tidal stream generators 212 which convert mechanical energy of water to electrical energy in the form of AC by means of a rotating magnetic field with a stationary armature. AC power is transmitted to the electrical grid 4 which in turn delivers same to consumers. Seawater flowing through the bends 211 may rotate blades of the tidal stream generator 212. A shaft (not shown) is coaxially provided a reduction gearbox (not shown) so that power may be transmitted from the reduction gearbox to the tidal stream generator 212 for generating electrical power. A hole 142 is provided on a lower portion of an outer of the electrical power generation arrangement 2 for maintenance purpose.

The drain tank 3 is connected to an end of the electrical energy generation device 21 so that seawater may flow from the electrical energy generation device 21 to the drain tank 3. The drain tank 3 includes an outlet 31 for discharging seawater to the sea. Specifically, seawater may flow to the sea through the outlet 31 if the drain tank 3 is provided above the surface of the seawater. Alternatively, a pump may be used to draw seawater from the outlet 31 to the sea if the drain tank 3 is provided below the surface of the seawater.

The invention has the following advantages and benefits in comparison with the conventional art:

Both the tidal stream generation devices 12 and the electrical energy generation device 21 are used to generate electrical energy, thereby increasing performance. No pollution. Tides are fully utilized.

The reduction gearbox 124 in cooperation with the tidal stream generation devices 12 or the tidal stream generator 212 can increase electrical power output.

While the invention has been described in terms of preferred embodiments, those skilled in the art will recognize that the invention can be practiced with modifications within the spirit and scope of the appended claims.

What is claimed is:

1. A generating apparatus for generating electrical power from a water flow to electrical energy, comprising:
a support structure;
an electrical power generation arrangement; and
a drain tank;
wherein the support structure includes a pipe extending out of the support structure to allow seawater to flow through, at least one tidal stream generation device in the pipe, a water discharging member in the pipe, and a water tank being in fluid communication with the pipe and proximate the water discharging member;
wherein each of the least one tidal stream generation device includes a turbine for directing seawater from the pipe therein, a shaft coaxially provided with and co-rotated with the turbine, a reduction gearbox operatively connected to the shaft, an output shaft extending out of the reduction gearbox, an alternator driven by the output shaft to convert mechanical energy to electrical energy in the form of alternating current (AC), and an electrical grid electrically connected to the alternator;
wherein the water discharging member is in fluid communication with the water tank so that the water tank is configured to store seawater flowing through the at least one tidal stream generation device and the water discharging member;
wherein the water tank includes an outlet proximate a bottom for flowing seawater to the electrical power generation arrangement;
wherein the electrical power generation arrangement includes at least one electrical energy generation device on a bottom;
wherein a level of the water tank is higher than a height of each of the at least one electrical energy generation device so that gravitation of seawater in the water tank is configured to flow to each of the at least one electrical energy generation device;
wherein each of the at least one electrical energy generation device includes a plurality of bends connected together and a plurality of tidal stream generators disposed in the bends;
wherein seawater flowing through the bends is configured to activate the tidal stream generators to convert mechanical energy to electrical energy in the form of AC;
wherein the electrical grid electrically connected to each of the tidal stream generators; and
wherein the drain tank is connected to an end of each of the at least one electrical energy generation device so that seawater is configured to flow from the electrical energy generation device to the drain tank; and
wherein the drain tank includes an outlet for discharging seawater to the sea.

2. The generating apparatus of claim 1, further comprising a water level indicator disposed on an upper portion of an outer surface of the water tank.

3. The generating apparatus of claim 1, further comprising at least one hole disposed on a lower portion of an outer surface of the water tank for discharging sea water out of the water tank.

4. The generating apparatus of claim 1, wherein a size of an inlet of the pipe is configured to adjust.

5. The generating apparatus of claim 1, wherein seawater is configured to flow to the sea through the outlet of the drain tank if the drain tank is disposed above the surface of seawater.

6. The generating apparatus of claim 1, wherein seawater is configured to flow into the tidal stream generation device for electrical power generation through the pipe if the support structure is disposed under the surface of seawater.
